(19) United States
(12) Patent Application Publication
(10) Pub. No.: US 2012/0070005 A1
(43) Pub. Date: Mar. 22, 2012

(54) STEREOPHONIC SOUND REPRODUCTION SYSTEM

(75) Inventors: Hiroshi INOU, Kariya-shi (JP); Mamoru Sawada, Yokkaichi-shi (JP)

(73) Assignee: DENSO CORPORATION, Kariya-city (JP)

(21) Appl. No.: 13/233,097

(22) Filed: Sep. 15, 2011

(30) Foreign Application Priority Data
Sep. 17, 2010 (JP) 2010-209781

(51) Int. Cl. H04R 5/00

(52) U.S. Cl. 381/17

(57) ABSTRACT

A stereophonic sound production system is provided which outputs audio signals in the form of sound through, for example, speakers to create virtual sound sources at desired locations in a three-dimensional space around a listener to develop a three-dimensional sound field. The virtual sound sources includes a direct sound source which produce a direct sound heard directly by the listener and N^{th} order reflected sound sources which produce N^{th} order reflected sounds resulting from reflection of the direct sound. The stereophonic sound production system produces audio signals to localize the N^{th} order reflected sound sources of the same order to the desired locations, as specified around a source-to-listener line extending from the direct sound source to the listener, thereby giving the listener a three-dimensional spatial perspective.

### CROSS REFERENCE TO RELATED DOCUMENT

The present application claims the benefit of priority of Japanese Patent Application No. 2010-209781 filed on Sep. 17, 2010, the disclosure of which is incorporated herein by reference.

### BACKGROUND OF THE INVENTION

1. Technical Field

The present invention relates generally to a stereophonic sound reproduction system which outputs audio signals from two or more audio signal outputting devices such as speakers or headphones so as to localize virtual acoustic sources to desired locations in a three-dimensional space, thereby reconstructing a stereophonic acoustic field.

2. Background Art

Japanese Patent First Publication No. 7-288899 discloses an sound image reproduction system which uses two-channel speakers to develop distance or spatial perspectives of sound images in various directions. Specifically, the sound image reproduction system works to convert an audio signal inputted through a signal input device into a digital form through an A/D converter and then input it to a signal processing circuit. The signal processing circuit processes the digital signal to produce through a direct sound localization device and a reflected sound localization device audio signals to be outputted from right and left speakers so as to create an illusion of location and distance of a sound image or broadness of a sound field selected by a listener.

The audio signals, as produced by the sound localization devices, are summed by two adders and converted into analog forms through D/A converters, which are in turn reproduced by the right and left speakers. This enables the listener to localize the sound image with an intended illusion of distance and direction.

The above prior art sound image reproduction system is designed to orient the direction of the reflected sound on a horizontal plane extending around the head of the listener, in other words, including locations of ears of the listener. The direct sound and the reflected sound, therefore, lie on the same horizontal plane around the listener, thereby undesirably creating a two-dimensional sound filed, not a true spatial sound field.

### SUMMARY

It is therefore an object to provide a stereophonic sound reproduction system which creates virtual acoustic sources at desired locations in a three-dimensional space to reconstruct a three-dimensional sound field.

According to an aspect of an embodiment, there is provided a stereophonic sound production system which comprises: (a) at least two audio signal outputting devices which output audio signals in the form of sound to create virtual sound sources at desired locations in a three-dimensional space around a listener, thereby developing a three-dimensional sound field, the virtual sound sources including a direct sound source which produce a direct sound heard directly by the listener and N^{th} order reflected sound sources which produce N^{th} order reflected sounds resulting from reflection of the direct sound where N is an integer more than or equal to one; (b) a direct sound source localizing circuit which produces audio signals to localize the direct sound source to the desired location in the three-dimensional space; (c) a reflected sound source localizing circuit which produces audio signals to localize the N^{th} order reflected sound sources of the same order to the desired locations, as specified around a source-to-listener line extending from the direct sound source to the listener; and (d) an audio signal combining circuit which combines the audio signals, as produced by the direct sound source localizing circuit and the reflected sound source localizing circuit, to produce the audio signals to be outputted from the audio signal outputting device respectively.

Specifically, a plurality of the N^{th} order reflected sound sources are created at the locations arrayed around the source-to-listener line, thereby giving the listener an acoustic three-dimensional perspective.

The stereophonic sound production system also enables the listener to perceive an acoustic image strongly in a direction toward the direct sound source and thus is useful for the case where it is required to draw the attention of the listener to a specified direction.

In the preferred mode of the embodiment, the reflected sound source localizing circuit works to localize the N^{th} order reflected sound sources so as to increase a distance between each of the N^{th} order reflected sound sources to the source-to-listener line as an increase in order of the N^{th} order reflected sound sources.

The distance between each of the N^{th} order reflected sound sources to the source-to-listener line is preferably increased exponentially as the increase in order of the N^{th} order reflected sound sources.

When the stereophonic sound production system is disposed in an environment where sound is reflected on a sound-reflective object such as a wall, each of the N^{th} order reflected sound sources is viewed as being located where a mirror-image of the direct sound source appears if the wall is assumed to be a mirror. This is because a source of sound reflected from the reflective object is viewed as being disposed at a location symmetrically opposed to the direct sound source with respect to the reflective object. Therefore, as the order of the N^{th} order reflected sound sources, in other words, the number of times the sound is reflected increases, the N^{th} order reflected sound sources are located farther away from the source-to-listener line, for example, exponentially. This creates a stereophonic (i.e., three-dimensional) sound field simulating reflection of sound within a real space enclosed with the reflective object such as a wall.

The reflected sound source localizing circuit may work to localize the N^{th} order reflected sound sources to the locations which are specified farther away from the listener along the source-to-listener line as the order of the N^{th} order reflected sound sources increases. Further, the reflected sound source localizing circuit preferably work to localize the N^{th} order reflected sound sources so that a distance between every adjacent two of the N^{th} order reflected sound sources increases as the order of the N^{th} order reflected sound sources increases.

Specifically, in a three-dimensional space closed by a sound-reflective object such as a wall, the sound pressure level of each of the N^{th} order reflected sounds to attenuate greatly as the number of reflections thereof increases. The stereophonic sound production system uses such great attenuation to create the three-dimensional sound field.

The stereophonic sound production system may be designed to move the locations of the N^{th} order reflected sound sources toward or away from the listener and determine the locations of the N^{th} order reflected sound sources so that as the N^{th} order reflected sound sources move relative to the listener along the source-to-listener line, a rate of change in distance between each of the N^{th} order reflected sound sources and the listener becomes greater than that between the direct sound source and the listener in a direction along the source-to-listener line.

Before reaching each ear of humans, a sound wave is usually reflected on the head (e.g., the nose) and a pinna of the ear, so that it interferes with the reflected waves. The sound pressure, therefore, changes during traveling from the sound source to the head, to the ear, and to the drum of the ear as a function of the frequency thereof. Such a frequency characteristic is called a head-related transfer function (HRTF). The head-related transfer function depends upon shapes of the head and the ears and the location (i.e., the azimuth) of a sound source. The human's ability to localize sound sources is known to be developed since the human is aware of his or her own head-related transfer function and the azimuth-independency thereof.

Accordingly, when the locations of the N^{th} order reflected sound sources, as created radially offset from the source-to-listener line, in other words, the distance or interval between each of the N^{th} order reflected sound sources and the listener is changed to be greater than that of the direct sound source and the listener changes, it will result in a greater change in angle at which the sound wave emanating from each of the N^{th} order reflected sound sources is incident to the ears of the listener than that at which the sound wave from the direct sound source is incident to the ears of the listener. A noticeable change in value of the head-related transfer function (i.e., the frequency characteristic) is, therefore, developed by changing the incident angle of the N^{th} order reflected sound in the above manner. This makes the listener feel a high degree of sense of presence when the virtual sound sources are moving, especially to or away from the listener.

The locations of the N^{th} order reflected sound sources may be determined approximately using a conic curve. The appearance of the conic curve is changed by changing the eccentricity thereof into the ellipse, the parabola, and the hyperbola. Such a change in appearance may be used to determine the locations where the N^{th} order reflected sound sources are to be created. This eliminates the need for retaining a large amount of numerical data on virtual environments needed to localize the N^{th} order reflected sounds.

The stereophonic sound production system may be mounted in a vehicle such as an automobile to permit a vehicle occupant to perceive information or warning sounds from specified directions. The stereophonic sound production system, as described above, makes the listener perceive a sound image strongly in a direction in which the direct sound source is localized and may also work to move the virtual sound sources (i.e., the N^{th} order reflected sound sources) to give the listener a high degree of sense of presence. The stereophonic sound production system is, thus, very useful in vehicles to draw the attention of the listener (e.g., a vehicle driver) to a specified direction or event.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a block diagram which illustrates a stereophonic sound production system according to an embodiment;

FIG. 2(a) is a schematic view which demonstrates travel paths of a direct sound and a reflected sound within a three-dimensional space;

FIG. 2(b) is a schematic view which illustrates a positional relation among a direct sound source, a reflected sound source, and a listener;

FIG. 3 is a schematic view which illustrates locations of a listener relative to a sound source within a closed space;

FIG. 4(a) is a perspective view which demonstrates a layout of a direct sound source and N^{th} order reflected sound source when a listener is in a first position 1 in FIG. 3;

FIG. 4(b) is a perspective view which demonstrates a layout of a direct sound source and N^{th} order reflected sound source when a listener is in a second position 2 in FIG. 3;

FIG. 4(c) is a perspective view which demonstrates a layout of a direct sound source and N^{th} order reflected sound source when a listener is in a third position 3 in FIG. 3;

FIG. 5(a) is an illustration which shows a positional relation between a direct sound source and N^{th} order reflected sound sources, as viewed from a listener at a first position 1 in FIG. 3;

FIG. 5(b) is an illustration which shows a positional relation between a direct sound source and N^{th} order reflected sound sources, as viewed from a listener at a second position 2 in FIG. 3;

FIG. 5(c) is an illustration which shows a positional relation between a direct sound source and N^{th} order reflected sound sources, as viewed from a listener at a third position 3 in FIG. 3;

FIG. 6 is a graph which illustrates an ellipse, a parabola, and a hyperbola resulting from the intersection of a plane with a cone which are used in determining locations of reflected sound source;

FIG. 7 is a view which illustrates an example of a layout of a direct sound source and N^{th} order reflected sound sources on a hyperbolic surface, as defined by a hyperbola when its eccentricity e is 1.5;

FIG. 8 is a view which illustrates an example of a layout of a direct sound source and N^{th} order reflected sound sources on a parabolic surface, as defined by a parabola when its eccentricity e is 1;

FIG. 9 is a view which illustrates an example of a layout of the direct sound source and N^{th} order reflected sound sources on an elliptical surface, as defined by an ellipse when its eccentricity e is 0.5;

FIG. 10(a) is a view which shows N^{th} order reflected sound sources which are located at an angular interval θ of 45° away from each other within a space which is circular in cross section;

FIG. 10(b) is a retinal view of FIG. 10(a);

FIG. 11(a) is a view which shows N^{th} order reflected sound sources which are located at an angular interval θ of 90° away from each other within a cubic space;

FIG. 11(b) is a retinal view of FIG. 11(a); and

FIG. 12 is a circuit diagram which shows a structure of a stereophonic sound field producing circuit of the stereophonic sound production system of FIG. 1.

### DESCRIPTION OF THE PREFERRED EMBODIMENTS

Referring to the drawings, wherein like reference numbers refer to like parts in several views, particularly to FIG. 1, there is shown a stereophonic sound production system 20 of an embodiment of the invention which is designed to output audio signals from two or more sound output devices such as speakers or headphones so as to localize a virtual acoustic source to a desired location in a three-dimensional space, thereby reconstructing a stereophonic sound field. The following discussion will refer to an example where the stereophonic sound production system 20 is installed in a vehicle such as an automobile.

Some modern automotive vehicles are equipped with an obstacle sensing device which detects an obstacle around the vehicle and warns the vehicle driver about the presence of the obstacle, an intelligent parking assist system (also known as an advanced parking guidance system) which assists the driver in parking the vehicle, and/or a navigation system which receives GPS signals to determine the location of the vehicle and provide information on traffic conditions and directions to the destination. For example, when the obstacle is found by the obstacle sensing device, a warning may be sounded from a direction where the obstacle exists to make the driver perceive the direction of the obstacle. Additionally, when the obstacle is approaching the vehicle, a warning sound source may be moved to the driver from the same direction as that of the obstacle to inform the driver of the fact that the obstacle is now approaching as well as the direction thereof. Conversely, when the obstacle is receding from the vehicle, the warning sound source may be moved away from the driver in the same direction as that of the obstacle to inform the driver of the fact that the obstacle is now getting away as well as the direction thereof.

Further, when the intelligent parking assist system gives the driver a guidance to suggest steering to the right, such guidance may be sounded from the right side of the driver to facilitate the ease with which the driver perceives the guidance acoustically. The sound source of the guidance may also be moved from the left to the right side of the driver. Further, when the navigation system navigates the route to the destination, a route guidance may be sounded from the direction in which the vehicle is to be steered to the right or left to make the driver acoustically perceive the direction in which the driver should turn the steering wheel. The route guidance may also be moved from an angular direction in which the vehicle is now advancing to that in which the vehicle should be turned.

In this way, it may be effective in vehicles such as automobiles to apparently move a warning or guidance sound source in a specified direction to draw the driver's attention. The stereophonic sound production system 20 is, as will be described later in detail, designed to make the listener perceive a sound image strongly in a direction in which a virtual sound source is localized and also move the virtual sound source to give the listener a high degree of sense of presence. The stereophonic sound production system 20 is, thus, very useful in vehicles to draw the attention of the listener (i.e., the driver) to a specified direction or event, but may alternatively be employed in commercial or home audio systems.

The stereophonic sound production system 20 is connected electrically to in-vehicle equipment 10 such as the obstacle sensing device, the intelligent parking assist system or the navigation system, as described above. The in-vehicle equipment 10 works to output an audio signal for sounding a warning or an announcement, sound source location information indicating the direction from which the driver (i.e., the listener) of the vehicle equipped with the stereophonic sound production system 20 (which will also be referred to as a system vehicle below) is to hear the audio signals and the distance to sound sources of the audio signals, and sound source movement information on how to move the sound sources if the azimuth of or distance to the sound sources from the listener is required to be changed.

The stereophonic sound production system 20 consists essentially of a sound source locating circuit 30, a stereo-sound field producing circuit 40, D/A converters 50A and 50B, amplifiers 60A and 60B, and speakers 70A and 70B. The stereophonic sound production systems 20 may alternatively be designed to have three or more channels of speakers.

The sound source locating circuit 30 monitors the sound source location information and the sound source movement information, as derived from the in-vehicle equipment 10, to determine target locations of virtual sound sources within a three-dimensional space. The virtual sound sources are made up of a direct sound source producing sound heard directly by the listener and reflected sound sources each of which produces sound resulting from N^{th} order reflection of the direct sound (N=an integer more than or equal to one). It is practical that the sound of each of the reflected sound sources is a one to four times reflected sound.

The direct sound source is positioned to a location, as indicated by the sound source location information given by the in-vehicle equipment 10. The N^{th} order reflected sound sources are positioned around a line extending from the direct sound source to the listener. The locations of the N^{th} order reflected sound sources will be described below in detail.

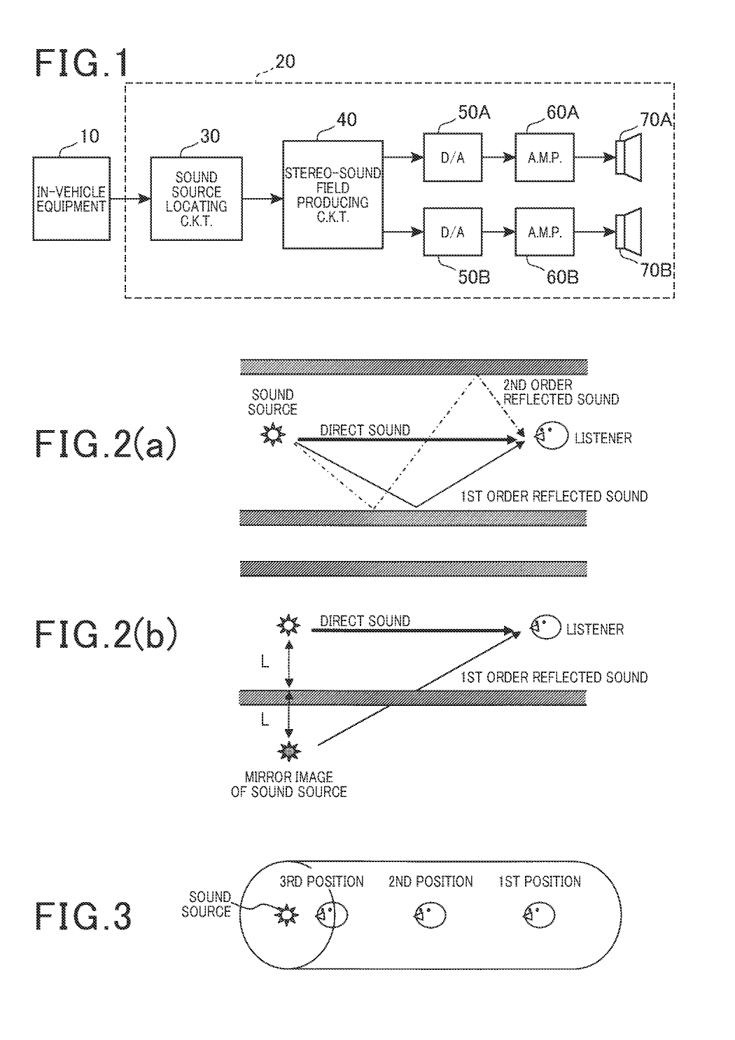

The stereophonic sound production system 20 is designed to locate the N^{th} order sound sources under the assumption that a space which is, as illustrated in FIGS. 2(a) and 2(b), defined by an upper, a lower, a right, and a left reflective wall which are all closed, such as in a tunnel, exist between a sound source and the listener.

When the above closed space is present between the sound source and the listener, the listener, as demonstrated in FIG. 2(a), will hear a direct sound transmitted directly from the sound source without undergoing any reflection on the walls and an N^{th} order reflected sound (i.e., sound reflected N-times on the walls). The direct sound source outputting such a direct sound is, therefore, disposed at the location, as illustrated in FIG. 2(a), specified by the sound source location information given by the in-vehicle equipment 10.

The N^{th} order reflected sound source is, as demonstrated in FIG. 2(b), located where a mirror-image of the original sound source appears if the wall is assumed to be a mirror. This is because when the wall is sound-reflective, a source of sound reflected from the wall is viewed as being disposed at a location symmetrically opposed to the original sound source with respect to the wall. Consequently, a first-order reflected sound source will be located where a mirror-image of the direct sound source appears. The second-order reflected sound source will be located where a mirror-image of the first-order sound source appears. The location of a three or more-order reflected sound source is specified in the same manner.

Therefore, as the order of the reflected sound source, in other words, the number of times the sound is reflected increases, the N^{th} order reflected sound source is located farther away from the line extending from the direct sound source to the listener (which will also be referred to as a source-to-listener line below). It is advisable that as the order of the reflected sound source increases, the distance between the N^{th} order reflected sound source and the source-to-listener line increase exponentially. The locating of a plurality of N^{th} order reflected sound sources in the above manner creates a stereophonic (i.e., three-dimensional) sound field simulating reflection of sound within a real space enclosed with reflective objects such as walls. The stereophonic sound production system 20 is so engineered as to create the N^{th} order reflected sound sources at locations, as described above.

The level of sound pressure of the N^{th} order reflected sound source will be described below.

The sound pressure of a spherical wave emanating from a vibrating sound source is given by

$$P ( t , r ) = j ω ρ \frac{Q {e}^{j ka}}{4 π ( 1 + j ka )} \cdot \frac{{e}^{j ω t - j kr}}{r} \qquad 1 )$$

where r is the distance (m) from the sound source, α is the radius (m) of the vibrating sound source, Q is the volume velocity (m³/s) of the vibrating sound source (i.e., the strength), ρ is the volume density (kg/m³) of air, k is a wave constant (1/m), ω is the angular frequency (rad/s), t is time, and j is an imaginary number.

Accordingly, the sound pressure of the spherical wave emitted from a point source where the radius of a tiny pulsating sphere is infinitesimal is expressed by Equation 2) and the level thereof is expressed by Equation 3) below.

$$\begin{matrix}P ( t , r ) = j ω ρ \frac{Q}{4 π} \cdot \frac{{e}^{j ω t - j kr}}{r} & 2 ) \\ \vert P ( t , r ) \vert = {α}^{N} \frac{ω ρ Q}{4 π r} & 3 )\end{matrix}$$

Therefore, if the coefficient of reflection of the walls is defined as α (<1), the level of the sound pressure the N^{th} order reflected sound is given by

$$\vert p ( t , r ) \vert = {α}^{N} \frac{ω ρ Q}{4 π r} \qquad 4 )$$

Eq. 4) shows that the absolute value of the sound pressure of the N^{th} order reflected sound is α^{N} times lower than that of the original or direct sound, in other words, the distance between the N^{th} order reflected sound source and the listener increases 1/α^{N} times that between the direct sound source and the listener.

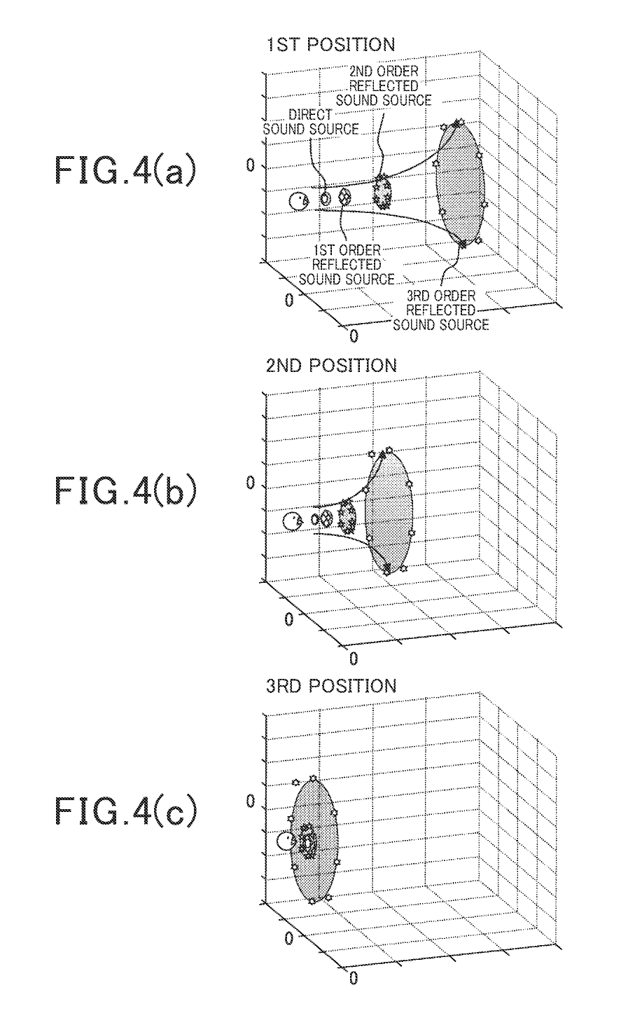

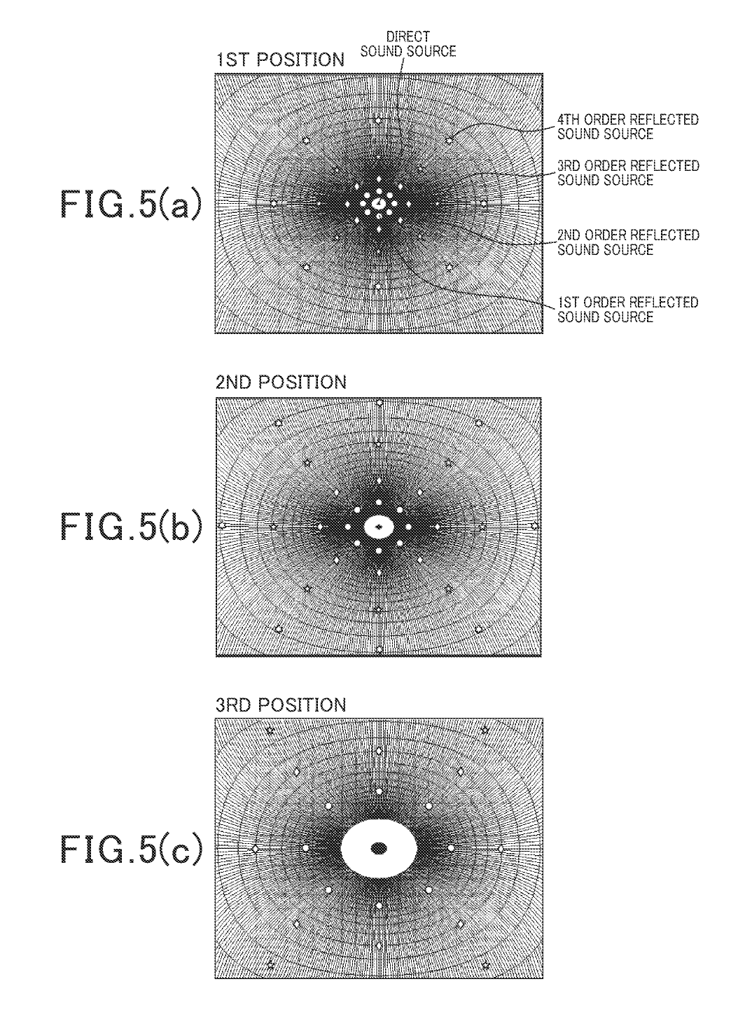

Consequently, when a hollow cylindrical space illustrated in FIG. 3, such as a tunnel, exists between the sound source and the listener, it is possible to create the N^{th} order reflected sound sources at locations, as demonstrated in FIGS. 4(a) to 4(c) and FIGS. 5(a) to 5(c).

FIG. 4(a) is a perspective view which shows an example of a possible layout of the N^{th} order reflected sound sources when the listener is at the first position farthest from the sound source in the space of FIG. 3. FIG. 5(a) is an illustration which shows a positional relation between the direct sound source and the N^{th} order sound sources, as viewed from the listener at the first position.

The sound emanating from the sound source within the hollow cylindrical space of FIG. 3 will be reflected uniformly on the wall of the space in all directions. The stereophonic sound production system 20 of this embodiment is engineered to develop sources of each of first- to fourth-order reflected sounds at locations defined at an angular interval of 45 degrees away from each other radially around the source-to-listener line. The interval between every adjacent two of the N^{th} order reflected sounds may alternatively be another angle such as 30°, 60°, or 90°, which will also be described later in detail.

The stereophonic sound production system 20 is designed based on the fact that the distance between each of the N^{th} order reflected sound sources and the listener increases 1/α^{N} times that between the direct sound source and the listener to create the N^{th} order reflected sound sources at locations farther away from the listener as the order of the reflected sound sources, in other words, the number of times the sound is reflected increases. Specifically, as demonstrated in FIG. 4(a), the interval between every adjacent two of the N^{th} order reflected sound sources is increased with an increase in number of times the sound emanating from the sound source is reflected, in other words, as the order of the reflected sound sources is increased along the source-to-listener line. This causes the sound pressure level of each of the N^{th} order reflected sounds to attenuate as the number of reflections thereof increases, thus giving the listener acoustic three-dimensional perspective.

FIG. 4(b) is a perspective view which shows an example of a possible layout of the N^{th} order reflected sound sources which can be created by the stereophonic sound reproduction system 20 when the listener is at the second position closer to the sound source in the space of FIG. 3 than the first position. FIG. 4(c) is a perspective view which shows an example of a possible layout of the N^{th} order reflected sound sources which can be created by the stereophonic sound reproduction system 20 when the listener is at the third position closest to the sound source in the space of FIG. 3. FIG. 5(b) is an illustration which shows a positional relation between the direct sound source and the N^{th} order reflected sound sources, as viewed from the listener at the second position. Similarly, FIG. 5(b) is an illustration which shows a positional relation between the direct sound source and the N^{th} order reflected sound sources, as viewed from the listener at the third position.

The interval between every adjacent two of the N^{th} order reflected sound sources when the listener is at each of the second and third positions is, like at the first position, selected to increase with an increase in number of times the sound emanating from the sound source is reflected, in other words, as the order of the reflected sound sources is increased along the source-to-listener line.

As the listener approaches the virtual sound sources (i.e., the direct sound source and the N^{th} order reflected sound sources), as demonstrated in FIGS. 4(b) and 4(c), along the source-to listener line, a change in location of each of the N^{th} order reflected sound sources (i.e., a rate of change in distance between each of the N^{th} order reflected sound sources and the listener) becomes greater than that between the direct sound source and the listener in a direction along the source-to-listener line. Such a change in location (i.e., the rate of change in the distance) also increases with an increase in order of the reflected sound sources.

Before reaching the ears, a sound wave is usually reflected on the head (e.g., the nose) and a pinna of the ear, so that it interferes with the reflected waves. The sound pressure, therefore, changes during traveling from the sound source to the head, to the ear, and to the drum of the ear as a function of the frequency thereof. Such a frequency characteristic is called a head-related transfer function (HRTF). The head-related transfer function depends upon shapes of the head and the ears and the location (i.e., the azimuth) of a sound source. The human's ability to localize sound sources is known to be developed since the human is aware of his or her own head-related transfer function and the azimuth-independency thereof.

When the locations of the N^{th} order reflected sound sources, as created radially of the source-to-listener line, in other words, the distance or interval between each of the N^{th} order reflected sound sources and the listener is, like in the stereophonic sound production system 20, changed to be greater than that of the direct sound source and the listener changes, it will result in a greater change in angle at which the sound wave emanating from each of the N^{th} order reflected sound sources is incident to the ears of the listener than that at which the sound wave from the direct sound source is incident to the ears of the listener. The stereophonic sound production system 20 further increases the rate of change in interval between each of the N^{th} order reflected sound sources and the listener as the order of the reflected sound sources increases. A noticeable change in value of the head-related transfer function (i.e., the frequency characteristic) may, therefore, be developed by changing the incident angle of the N^{th} order reflected sound in the above manner. The stereophonic sound production system 20 is, thus, designed to employ the change in frequency characteristic of sound depending upon the change in incident angle of the N^{th} order reflected sound to make the listener feel a high degree of sense of presence when the virtual sound source is moving, especially to or away from the listener.

The stereophonic sound production system 20 is engineered to use a conic curve (i.e., a conic section) to approximately determine locations where each of the N^{th} order reflected sound sources are to be created. This eliminates the need for retaining a large amount of numerical data on virtual environments needed to localize the N^{th} order reflected sound sources. The positional relation of the N^{th} order reflected sound sources to the direct sound source, as determined using the conic curve, is equivalent to that in actual environments, thus giving a high degree of sense of presence to the listener.

In the case of use of the conic curve, the distance between the source-to-listener line and each of the N^{th} order reflected sound sources may not increase exponentially with an increase in order of the reflected sound sources (i.e., the number of reflections of sound). For example, this is the case where the locations of the N^{th} order reflected sound sources of the different orders are determined using the same conic curve. The three-dimensional sound field is, however, created by increasing the distance between the source-to-listener line and each of the N^{th} order reflected sound sources as the order of the reflected sound sources increases.

How to determine the locations of the N^{th} order reflected sound sources using the conic curve will be described below. The conic curve (also called the conic section) is a genetic term used to refer to a curve obtained by intersecting a cone with a plane which does not pass through the vertex of the cone. The conic curve is mathematically expressed by

$$r = \frac{ce}{1 + e cos ϕ} \qquad 5 )$$

where e is the eccentricity. When the value of the eccentricity e is in a range of 0<e<1, the conic curve will be the ellipse. When the value of the eccentricity e is one (i.e., e=1), the conic curve will be the parabola. When the value of the eccentricity e is greater than one (i.e., e>1), the conic curve will be hyperbola.

The types of conic curve will be described simply. Assume for instance that there are straight lines m and/which intersects with each other at a point O (i.e., the apex) in a space. When the line l is rotated around the line m (i.e., the axis), the line l (i.e., the generatrix) will draw two right circular cones above and below the apex O. The ellipse, the parabola, or the hyperbola will be defined by the angle the plane cutting through the cones makes with the line l (i.e., the generatrix). The eccentricity e is a definition used to refer to an inclination or angle of the plane relative to the generatrix l. When the plane is parallel to the generatrix l, the parabola will appear. When the plane extends in nonparallel to the generatrix l through either one of the cones, the ellipse will appear. When the plane extends in nonparallel to the generatrix 1 through both the cones, the hyperbola will appear at each of the cones. When the plane extends perpendicular to the axis m, the circle will appear which may be used in determining the locations of the N^{th} order reflected sound sources.

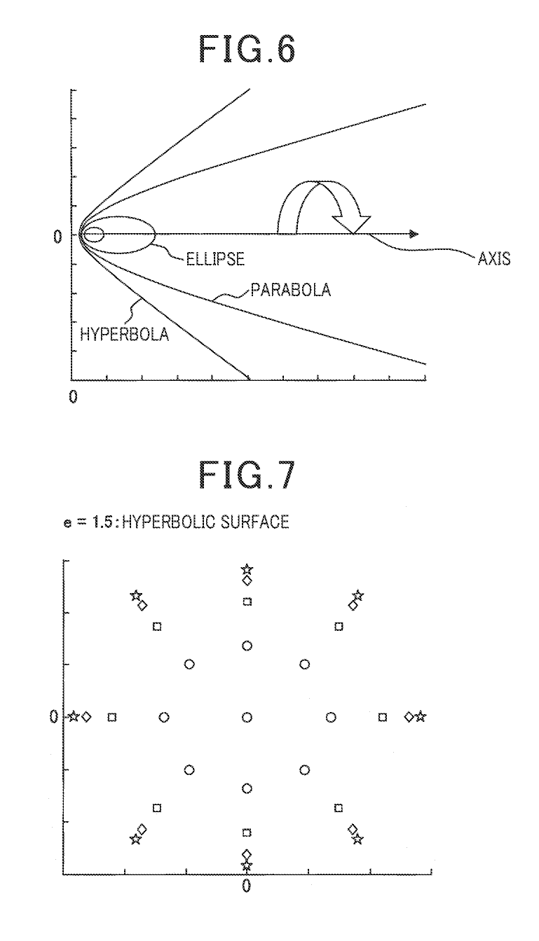

FIG. 6 is a graph which illustrates the ellipse, the parabola, and the hyperbola resulting from the intersection of the plane with the cone. Rotating the plane of FIG. 6 around the axis, as denoted by an arrow, will result in conversion of the ellipse, the parabola, and the hyperbola into three-dimensional geometries or curved surfaces. The direct sound source and the N^{th} order reflected sound sources are created on a selected one of the curved surfaces. Specifically, the direct sound source is located at the apex, as illustrated on the left side of FIG. 6. The N^{th} order reflected sound sources are, as described above, located farther away from the direct sound source along the axis as the order of the reflected sound sources increases. The interval between every adjacent two of the N^{th} order reflected sound sources is also increased on the curved surface as an increase in order of the reflected sound sources. The locations of the direct sound source and the N^{th} order reflected sound sources on each of the curved surfaces are determined in the above manner and stored in the sound source locating circuit 30.

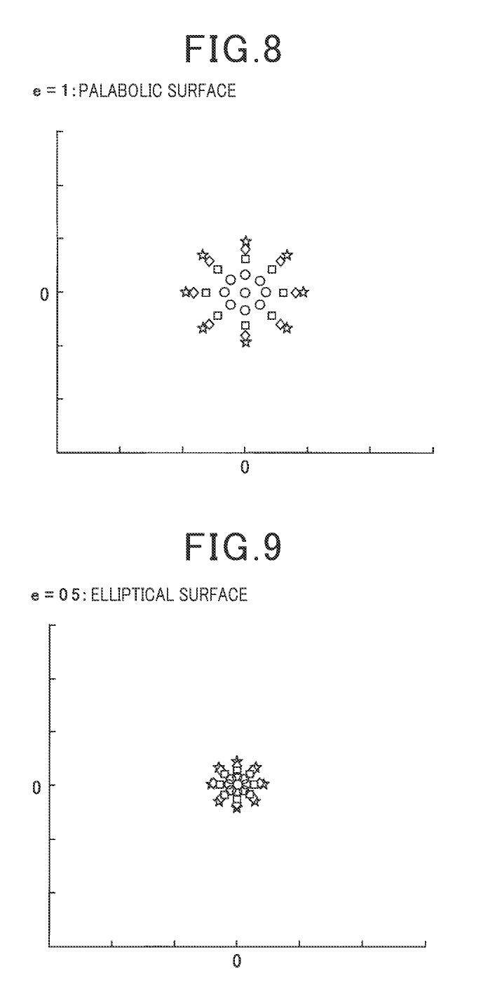

FIG. 7 illustrates an example of the layout of the direct sound source and the N^{th} order reflected sound sources on a hyperbolic surface, as defined by the hyperbola when the eccentricity e is 1.5. FIG. 8 illustrates an example of the layout of the direct sound source and the N^{th} order reflected sound sources on a parabolic surface, as defined by the parabola when the eccentricity e is 1. FIG. 9 illustrates an example of the layout of the direct sound source and the N^{th} order reflected sound sources on an elliptical surface, as defined by the ellipse when the eccentricity e is 0.5.

The layouts of the direct sound source and the N^{th} order reflected sound sources in FIGS. 7 to 9 are closely similar to those in FIGS. 5(a) to 5(c). This means that the locations where the N^{th} order reflected sound sources are to be created relative to the direct sound source are determined using the appearance of the conic curve (i.e., the ellipse, the parabola, or the hyperbola). This eliminates the need for retaining a large amount of numerical data on virtual environments needed to localize the N^{th} order reflected sound sources. The positional relation of the N^{th} order reflected sound sources to the direct sound source, as determined using the conic curve, is equivalent to that in actual environments, thus giving a high degree of sense of presence to the listener.

Which of the cone curves (i.e., the ellipse, the parabola, and the hyperbola) should be used to determine the positional relation between the direct sound source and the N^{th} order reflected sound source may be determined as a function of the distance at which the virtual sound source (i.e., the direct sound source) is required to be localized away from the listener. The shape of the cone curve used to determine the locations of the N^{th} order reflected sound sources is preferably changed by changing the eccentricity e for different orders of the reflected sound sources in order to enhance, like in FIG. 4(a), the increase in distance between each of the N^{th} order reflected sound sources and the source-to-listener line with an increase in order of the reflected sound sources.

A plurality of ellipses or hyperbolas which are defined with different values of the eccentricity e may be used to establish a plurality of positional relations between the direct sound source and the N^{th} order reflected sound sources as a function of distances between the virtual sound sources and the listener.

The above discussion has been made under the condition where the hollow cylindrical space illustrated in FIG. 3, such as a tunnel, exists between the sound source and the listener, so that a sound wave emanating from the sound source is reflected uniformly on the surrounding wall in all directions. From which direction the reflected sound emanates depends upon the configuration of the space existing between the sound source and the listener.

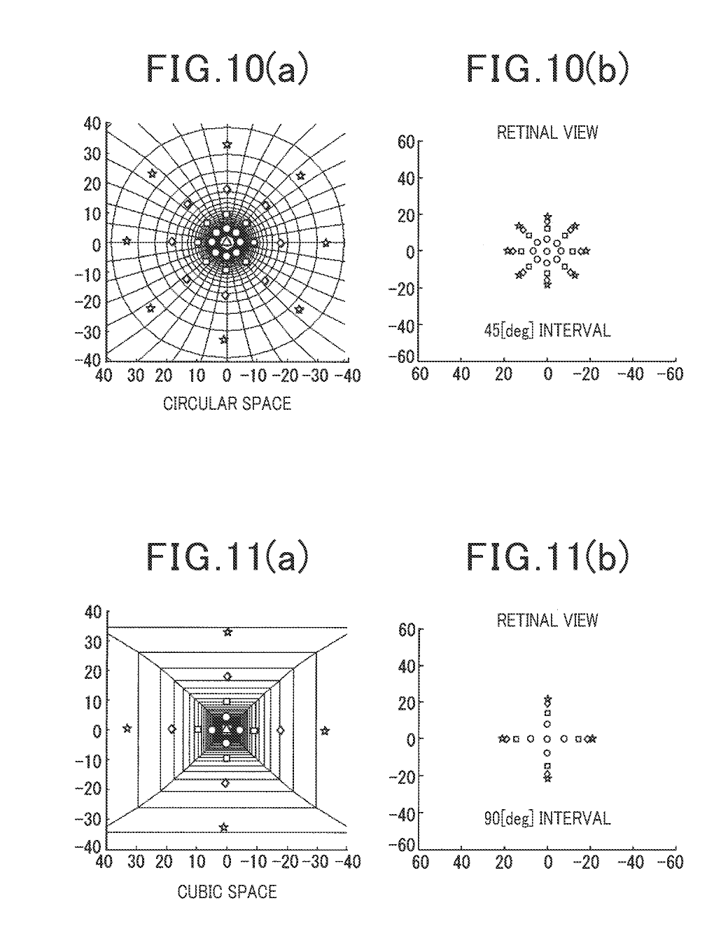

Specifically, when the space is circular in cross section, the N^{th} order reflected sound sources are located at an angular interval θ of 45° away from each other, as illustrated in FIG. 10(a), or at an angular interval θ of 30° away from each other.

When the space is cubic such as a gallery or a hall, as illustrated in FIG. 11(a), the sound is reflected by upper, lower, right, and left walls. The N^{th} order reflected sound sources are, therefore, created at an angular interval θ of 90° away from each other, as demonstrated in FIGS. 11(a) and 11(b).

The reflected sound, as can be seen from the above discussion, depends upon the positional relation between the listener and the reflective surfaces. The sound field produced by the stereophonic sound production system 20, therefore, includes information about the shape of a surrounding environment. Conversely, the locations where the N^{th} order reflected sound sources are to be created may be determined based on the geometry of a space in which the sound filed is to be produced by the stereophonic sound production system 20. The N^{th} order reflected sound sources, however, need not necessarily be arrayed at equi-intervals away from each other around the source-to-listener line. For instance, the N^{th} order reflected sound sources may be created within a range of 180° around the sound source to develop a sound field within a space bounded by a half-rounded wall. Alternatively, the N^{th} order reflected sound sources may be created on only three of four surrounding walls, such as the ones of FIG. 11(a), to develop a sound field within an closed space with an opening oriented in a single specified direction.

Next, the stereo-sound field producing circuit 40 will be described below in detail.

The stereo-sound field producing circuit 40 works to produce acoustic signals so that the listener will hear direct and reflected sounds as if they have come from the direct sound source and the N^{th} order sound sources arrayed by the sound source locating circuit 30.

The acoustic signals, as outputted by the stereo-sound field producing circuit 40, are converted by the D/A converters 50A and 50B into analog acoustic signals. The analog acoustic signals are amplified by the amplifiers 60A and 60B and then outputted from the speakers 70A and 70B.

The two speakers 70A and 70B are disposed at locations preselected relative to the listener. The listener hears the acoustic signals, as reproduced by the speakers 70A and 70B, through his or her ears. There are four propagation channels (i.e., paths) among the speakers 70A and 70B and the left and right ears of the listener. The waveform of the acoustic signal is changed depending upon the condition of each of the propagation channels (i.e., the head-related transfer functions for the ears) during traveling. The head-related transfer functions are different for incident angles of the sound waves from the upward, downward, right-hand, and left-hand directions.

There is also a propagation channel extending from the location of each of the direct sound source and the N^{th} order reflected sound sources to each of the left and right ears of the listener. The waveform of the acoustic signal, as outputted from each of the sound sources, is changed depending upon the head-related transfer function for a corresponding one of the propagation channels. When the waveform of the acoustic signal transmitted from each of the sound sources to the left and right ears of the listener is identical with that transmitted from the speakers 70A and 70B to the left and right ears of the listener, it will cause the listener to perceive each of the sound sources as being placed at the location specified by the sound source locating circuit 30.

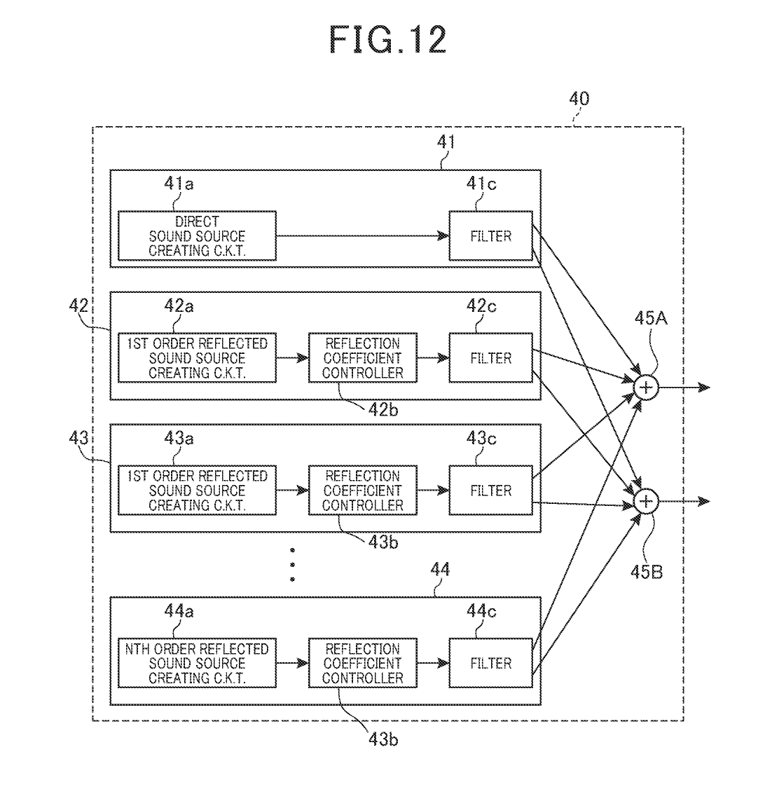

The stereo-sound field producing circuit 40, as illustrated in FIG. 12, consists of a direct sound source localizing circuit 41 and N^{th} order reflected sound source localizing circuits 42, 43, and 44. For the sake of simplicity of illustration, FIG. 12 shows the two first order reflected sound source localizing circuits 42 and 43 and the one N^{th} order reflected sound source localizing circuit 44, but however, the stereo-sound field producing circuit 40 is actually equipped with as many N^{th} order reflected sound source localizing circuits as the N^{th} order reflected sound sources required to be virtually created by the sound source locating circuit 30. For instance, in the case where the stereophonic sound production system 20 is designed to create a maximum of four first order reflected sound sources, a maximum of four second order reflected sound sources, and a maximum of four third order reflected sound sources, the stereo-sound field producing circuit 40 includes four first order reflected sound source localizing circuits, four second order reflected sound source localizing circuits, and four third order reflected sound source localizing circuits.

The direct sound source localizing circuit 41 is equipped with a direct sound source creating circuit 41a and a filter 41c. The direct sound source creating circuit 41a calculates a transfer function based on a specified location of the direct sound source required to be created using a corresponding one of the above described head-related transfer functions so that the waveform of acoustic signals which are outputted from the speaker 70A and 70B and reach the left and right ears of the listener may match up with that of an acoustic wave reaching the left and right ears of the listener from the location of the direct sound source. The calculated transfer function is set in the filter 41c. Similarly, the N^{th} order reflected sound sources 42, 43, and 44 are equipped with N^{th} order reflected sound source creating circuits 42a, 43a, and 44a and filters 42c, 43c, and 44c, respectively. Each of the N^{th} order reflected sound source creating circuits 42a, 43a, and 44a calculates a transfer function based on a specified location of a corresponding one of the N^{th} order reflected sound sources required to be created using a corresponding one of the head-related transfer functions so that the waveform of acoustic signals which are outputted from the speaker 70A and 70B and reach the left and right ears of the listener may match up with that of an acoustic wave reaching the left and right ears of the listener from the location of the corresponding one of the N^{th} order reflected sound sources. The calculated transfer function is set in a corresponding one of the filters 42c, 43c, and 44c. The head-related transfer functions are, as described above, determined in advance for incident angles of the direct sound source and the N^{th} order reflected sound sources to the ears of the listener and stored in the direct sound source localizing circuit and N^{th} order reflected sound source localizing circuits 42, 43, and 44, respectively.

The transfer functions, as derived in the above manner, are used as the filters 41c, 42c, 43c, and 44c to perform the convolution operation on an audio signal, as outputted from the in-vehicle equipment 10, to produce acoustic signals to be reproduced by the speakers 70A and 70B. The stereo-sound field producing circuit 40 also include adders 45A and 45B. Each of the adders 45A and 45B adds the acoustic signals, as produced by the filters 41c, 42c, 43c, and 44c, to output a combined acoustic signal to a corresponding one of the speakers 70A and 70B. The listener hears the acoustic signals reproduced by the speakers 70A and 70B and perceives the sounds as if they have come from the direct sound source and the N^{th} order sound sources arrayed by the sound source locating circuit 30 with the high realistic sensation.

The direct sound source localizing circuit 41 and the N^{th} order reflected sound source localizing circuits 42, 43, and 44, as described above, include the direct sound source creating circuit 41a and the N^{th} order reflected sound source creating circuits 42a, 43a, and 44a. The direct sound source creating circuit 41a and the N^{th} order reflected sound source creating circuits 42a, 43a, and 44a determine target distances between the listener and the direct sound source and the N^{th} order reflected sound sources and target three-dimensional azimuths thereof so as to establish a spatial layout of the sound sources specified by the sound source locating circuit 30. The direct sound source creating circuit 41a and the N^{th} order reflected sound source creating circuits 42a, 43a, and 44a also calculate delay times for the audio signals as a function of the above determined distances and required pressure levels of the audio signals. The transfer functions are, as described above, derived based on the distances to and the azimuths of the direct sound source and the N^{th} order reflected sound sources and set in the filters 41c, 42c, 43c, and 44c, respectively.

The N^{th} order reflected sound localizing circuits 42, 43, and 44 also include reflection coefficient controllers 42b, 43b, and 44b, respectively. The reflection coefficient controllers 42b, 43b, and 44b are each responsive to requests from the listener to control or determine the coefficient of reflection of sound wave on the wall of a three-dimensional space in which the listener is present. The reflection coefficient controllers 42b, 43b, and 44b then correct the sound pressures, as calculated by the N^{th} order reflected sound source creating circuits 42a, 43a, and 44a, based on the determined coefficients of reflection, thereby creating a three-dimensional sound field of interest to the listener.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments which can be embodied without departing from the principle of the invention as set forth in the appended claims.

For instance, the sound source locating circuit 30 may alternatively be designed to determine a target locational relation among the direct sound source and the N^{th} order reflected sound sources using known techniques other than the use of the conic sections, as described above.

The sound source locating circuit 30 may also be designed to determines target locations of the N^{th} order reflected sound sources so that they move toward or away from the listener while keeping the distance to the source-to-listener line constant. In this case, only the distances between the listener and the N^{th} order reflected sound sources are changed, thus facilitating mathematical calculation of the positional relation of the N^{th} order reflected sound sources to the direct sound source. The movement of the N^{th} order reflected sound sources toward or away from the listener results in changes in incident angles of the N^{th} order reflected sound sources to the ears of the listener, thus giving a high degree of sense of presence to the listener.

What is claimed is:

1. A stereophonic sound production system comprising:
at least two audio signal outputting devices which output audio signals in the form of sound to create virtual sound sources at desired locations in a three-dimensional space around a listener, thereby developing a three-dimensional sound field, the virtual sound sources including a direct sound source which produce a direct sound heard directly by the listener and N^{th} order reflected sound sources which produce N^{th} order reflected sounds resulting from reflection of the direct sound where N is an integer more than or equal to one;
a direct sound source localizing circuit which produces audio signals to localize the direct sound source to the desired location in the three-dimensional space;
a reflected sound source localizing circuit which produces audio signals to localize the N^{th} order reflected sound sources of the same order to the desired locations, as specified around a source-to-listener line extending from the direct sound source to the listener; and
an audio signal combining circuit which combines the audio signals, as produced by the direct sound source localizing circuit and the reflected sound source localizing circuit, to produce the audio signals to be outputted from the audio signal outputting device respectively.

2. A stereophonic sound production system as set forth in claim 1, wherein the reflected sound source localizing circuit works to localize the N^{th} order reflected sound sources so as to increase a distance between each of the N^{th} order reflected sound sources to the source-to-listener line as an increase in order of the N^{th} order reflected sound sources.

3. A stereophonic sound production system as set forth in claim 2, wherein the distance between each of the N^{th} order reflected sound sources to the source-to-listener line is increased exponentially as the increase in order of the N^{th} order reflected sound sources.

4. A stereophonic sound production system as set forth in claim 2, wherein the reflected sound source localizing circuit works to localize the N^{th} order reflected sound sources to the locations which are specified farther away from the listener along the source-to-listener line as the order of the N^{th} order reflected sound sources increases.

5. A stereophonic sound production system as set forth in claim 4, wherein the reflected sound source localizing circuit works to localize the N^{th} order reflected sound sources so that a distance between every adjacent two of the N^{th} order reflected sound sources increases as the order of the N^{th} order reflected sound sources increases.

6. A stereophonic sound production system as set forth in claim 1, wherein the locations of the N^{th} order reflected sound sources are movable with time toward or away from the listener, and wherein as the N^{th} order reflected sound sources move relative to the listener along the source-to-listener line, a rate of change in distance between each of the N^{th} order reflected sound sources and the listener becomes greater than that between the direct sound source and the listener in a direction along the source-to-listener line.

7. A stereophonic sound production system as set forth in claim 1, wherein the locations of the N^{th} order reflected sound sources are determined approximately using a conic curve.

8. A stereophonic sound production system as set forth in claim 1, wherein the stereophonic sound production system is mounted in a vehicle to permit a vehicle occupant to perceive information or warning sounds from specified directions.
